(19) United States
(12) Patent Application Publication
(10) Pub. No.: US 2004/0010410 A1
(43) Pub. Date: Jan. 15, 2004

(54) System and method for processing voice command

(75) Inventors: Jee-Eun Oh, Seoul (KR); Sung-Hoon Hwang, Suwon-si (KR); Hyung-Jin Seo, Suwon-si (KR); Yu-Seong Jeon, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/614,034

(22) Filed: Jul. 8, 2003

(30) Foreign Application Priority Data
Jul. 11, 2002 (KR) 2002-40403

(51) Int. Cl. G10L 15/00

(52) U.S. Cl. 704/246

(57) ABSTRACT

Provided are a voice command processing system and method. A voice command processing method includes constructing a plurality of databases, in which voice commands including an operation name are stored, receiving a voice command to separate the received voice command into an operation name and an object name, finding a database corresponding to the operation name within the plurality of databases, and finding the object name in the found database. According to the voice command processing system and method, time required to access a database corresponding to a voice command input by the user can be reduced.

### BACKGROUND OF THE INVENTION

This application claims the priority of Korean Patent Application No. 2002-40403 filed on Jul. 11, 2002, in the Korean Intellectual Property Office, the disclosure of which is incorporated herein in its entirety by reference.

1. Field of the Invention

The present invention relates to the field of speech recognition, and more particularly, to a system and method for processing a voice command in which database storing voice commands based on an operation name are constructed, thereby reducing time required to access a database corresponding to an input voice command when processing the input voice command.

2. Description of the Related Art

FIG. 1 is a block diagram showing the architecture of a related art voice command processing system. The related art voice command processing system includes a microphone 100, a voice recognition engine 101 having a voice recognition and control unit 101-1 and a database 101-2, and a speaker 102.

If a user inputs a voice command through the microphone 100, the voice recognition and control unit 101-1 analyzes the input voice command, searches for the same command as the analyzed voice command in the database 101-2, and then executes the command obtained from the database 101-2. When the voice recognition and control unit 101-1 cannot analyze the input voice command, the voice recognition and control unit 101-1 requests through the speaker 102 that the user re-inputs the voice command.

However, the related art has various problems and disadvantages. For example, but not by way of limitation, when voice commands are input, they are stored in the database 101-2 of the voice recognition engine 101 and are not subjected to subsequent organization. Thus, it takes a long time for the voice recognition and control unit 101-1 to access the same voice command as the input voice command within many voice commands stored in the database 101-2, for analyzing the input voice command and executing the analyzed voice command. Thus, the more voice commands the user inputs, the longer it takes for the voice recognition and control unit 101-1 to access the voice commands.

### SUMMARY OF THE INVENTION

The present invention provides a method for processing a voice command in which databases storing voice commands based on an operation name are constructed, a voice command input by the user is separated into meaningful terms, and only a database corresponding to the meaningful terms is searched within the constructed databases, thereby reducing time required to access the database corresponding to the input voice command when processing the input voice command.

The present invention also provides a voice command processing system in which databases storing voice commands based on an operation name are constructed, a voice command input by the user is separated into meaningful terms, and only a database corresponding to the meaningful terms is searched within the constructed databases, thereby reducing time required to access the database corresponding to the input voice command when processing the input voice command.

According to an aspect of the present invention, there is provided a voice command processing method. The method comprises (a) constructing a plurality of databases in which respective voice commands, including an operation name, are stored in each of the databases, (b) receiving one of the voice commands and separating the received voice command into terms that include the operation name and an object name, (c) finding a database corresponding to the operation name within the databases, and (d) finding the object name in the database corresponding to the operation name found in (c).

According to another aspect of the present invention, there is provided a voice command processing system including a plurality of databases configured to store respective voice commands, each of which includes an operation name, a separating unit which receives one of the voice commands, and separates the received voice command into the operation name and an object name, and a control unit which finds a database corresponding to the operation name within the plurality of databases, finds the object name in the found database, and executes the received voice command.

Further, according to yet another aspect of the present invention, there is provided a computer-readable medium configured to store a set of instructions for voice command processing method. The instructions comprise (a) constructing a plurality of databases in which respective voice commands, including an operation name, are stored in each of the databases, (b) receiving one of the voice commands and separating the received voice command into at least one term that includes the operation name and an object name, (c) finding a database corresponding to the operation name within the databases and (d) finding the object name in the database corresponding to the operation name found in (c).

### BRIEF DESCRIPTION OF THE DRAWINGS

The above and other aspects and advantages of the present invention will become more apparent by describing in detail preferred embodiments thereof with reference to the attached drawings in which:

FIG. 1 is a block diagram showing the architecture of a conventional voice command processing system;

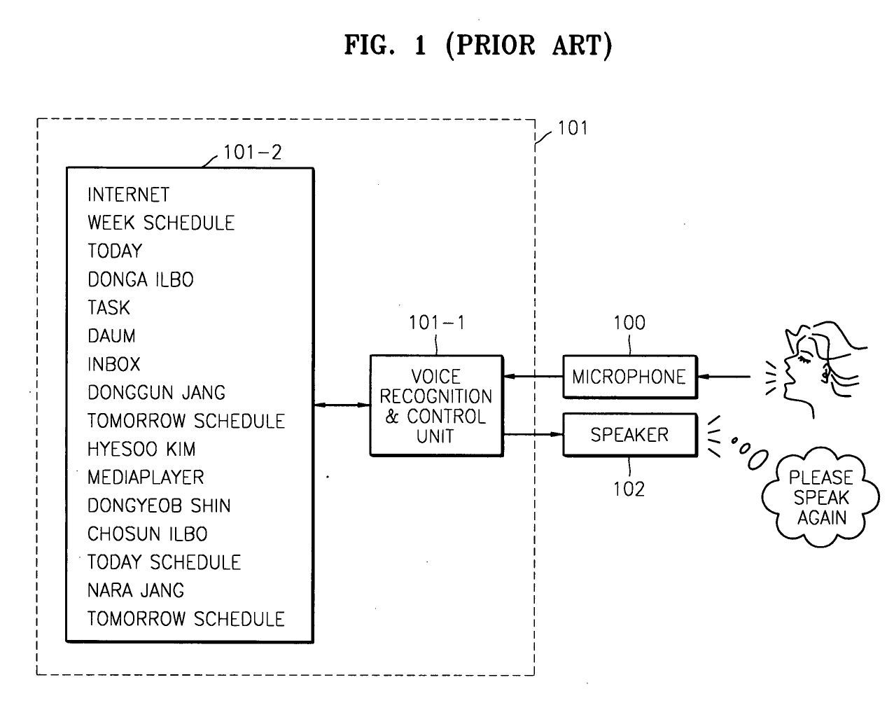

FIG. 2 is a block diagram showing the architecture of a voice command processing system according to an exemplary, non-limiting embodiment of the present invention; and

FIG. 3 is a flowchart showing a method for processing a voice command according to an exemplary, non-limiting embodiment of the present invention.

### DETAILED DESCRIPTION OF THE INVENTION

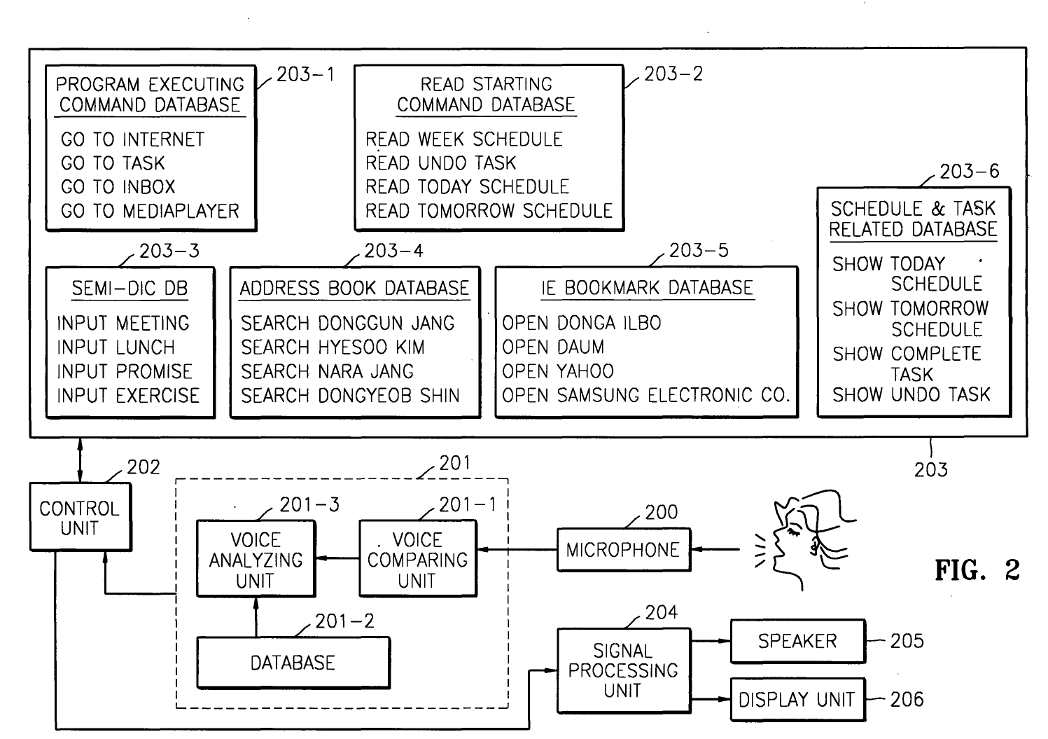

Referring to FIG. 2, which is a block diagram showing the architecture of a voice command processing system according to the present invention, the voice command processing system includes a microphone 200, a voice recognition engine 201 having a voice comparing unit 201-1, a database 201-2, and a voice analyzing unit 201-3, a control unit 202, a voice command database 203, a signal processing unit 204, a speaker 205, and a display unit 206.

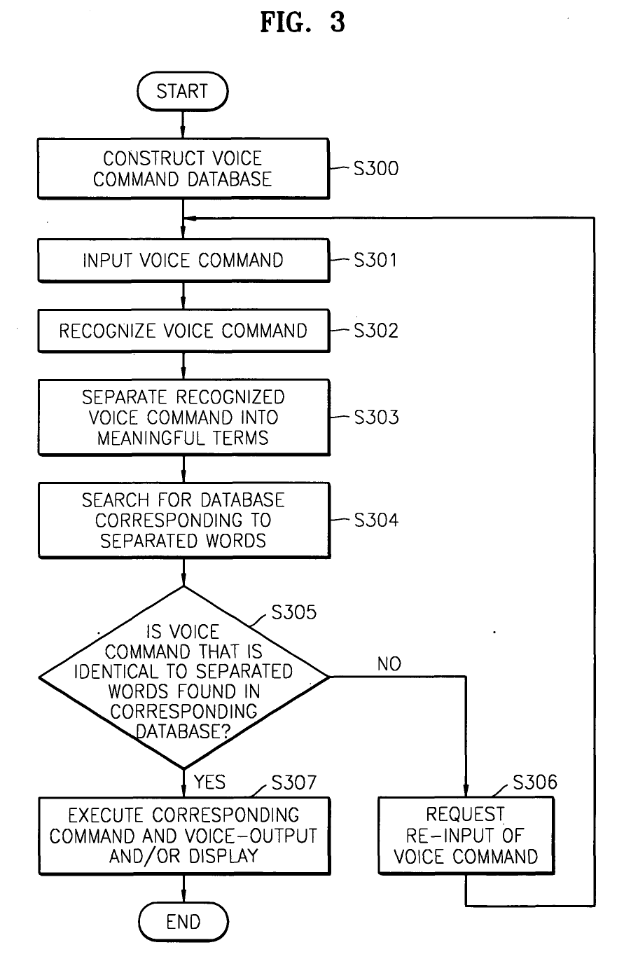

FIG. 3 is a flowchart showing a method for processing a voice command according to the present invention. The method for processing the voice command comprises a step S300 of constructing voice command databases, a voice command input step S301, a voice recognition step S302, a step S303 of separating the recognized voice command into meaningful terms, a step S304 of searching for a database corresponding to the separated words within the constructed voice command databases, a step S305 of determining whether a voice command that is identical to the separated words is found in the searched database, a step S306 of requesting re-input of the voice command, and a step S307 of voice-outputting and/or displaying a result of executing the corresponding voice command.

The present invention can be applied to any kind of speech recognition machine such as an embedded mobile terminal, a speech recognition toy, a speech recognition language learning machine, a speech recognition game, a speech recognition PCS (personal communication system), a speech recognition household electric appliance, a speech recognition automated guide system as well as to a machine for speech recognition home automation, speech recognition browser, and making speech recognition stock transaction, and the like.

As shown in FIG. 2, the voice command processing system includes the voice command database 203, which is constructed based on an operation name. The voice command database 203 includes a program executing command database 203-1 for executing programs, a command database 203-2 which starts with ‘Read’ and reads information, an input word database 203-3 including ‘Input’ word, an address book database 203-4 for supplying address information, an IE bookmark database 203-5 for supplying bookmark information in Internet Explorer, and a schedule & task related database 203-6 for supplying schedule related information. The number and kind of databases included in the voice command database 203 are not limited to the foregoing disclosure. Accordingly, databases may be freely added to or deleted from the voice command database 203.

The user inputs a voice command through the microphone 200 to obtain information. At this time, the user must input the voice command including an operation name. For example, when the user wants to connect to the Internet, the user inputs a voice command “Go to Internet” through the microphone 200.

The voice recognition engine 201 recognizes and analyzes the voice command sent from the microphone 200, and outputs the recognized voice command to the control unit 202. Specifically, the voice comparing unit 201-1 converts the voice command sent from the microphone 200 into a predetermined frequency or a constant level to compare with a reference value stored in the database 201-2, and outputs the recognition result. The voice analyzing unit 201-3 analyzes the recognized voice command output from the voice comparing unit 201-1, and separates the recognized voice command into meaningful terms. For example, but not by way of limitation, the voice analyzing unit 201-3 separates the voice command “Go to Internet” into the meaningful terms “Go to” and “Internet”. Here, “Go to” is an operation name, and “Internet” is an object name.

The control unit 202 accesses a database corresponding to the meaningful terms including the operation name and the object name, within the voice command database 203, and controls the command execution. If the recognized voice command including the operation name and the object name is output, the control unit 202 first reads the operation name, and finds a database corresponding to the operation name within the voice command database 203. After finding the database corresponding to the operation name, the control unit 202 finds the object name in the found database. For example, after the recognized voice command including the operation name “Go to” and the object name “Internet” is output from the voice recognition engine 201, the control unit 202 finds the program executing command database 203-1 starting with “Go to” by searching the voice command database 203. Thereafter, the control unit 202 finds the object name “Internet” by searching the program executing command database 203-1. In other words, the control unit 202 searches for only the database corresponding to the operation name without searching through all of the commands included in the voice command database 203, and finds the object name in the searched database. That is, the control unit 202 searches for the object name “Internet” in the program executing command database 203-1, calls a program associated with the object name, and executes the program. However, when it is impossible to search the input voice command in the database 203, such as when the user inaccurately inputs the voice command, the control unit 202 can request that the user re-input the voice command.

The signal processing unit 204 processes a signal for outputting a voice command execution result to the speaker 205 and/or the display unit 206. Further, in a case where the control unit 202 requests the re-input of the voice command, the signal processing unit 204 outputs a voice command re-input request signal to the speaker 205 and/or the display unit 206.

The method of processing a voice command will now be described with reference to FIG. 3. The voice command database 203 is constructed to a speech recognition machine, in step S300. As described above and shown in FIG. 2, the voice command database 203 includes a program executing command database 203-1 for executing programs, a command database 203-2, which starts with ‘Read’ and reads information, an input word database 203-3 including ‘Input’ word, an address book database 203-4 for supplying address information, an IE bookmark database 203-5 for supplying bookmark information in Internet Explorer, a schedule & task related database 203-6 for supplying schedule related information. Here, the number and kind of databases included in the voice command database 203 are not limited thereto. Accordingly, databases may be freely added to or deleted from the voice command database 203.

The user inputs the voice command through the microphone 200, to obtain information in step S301. At this time, the user must input the voice command including the operation name. For example, when the user wants to know the address of a person, for example, “Donggun Jang”, the user inputs the voice command “Search Donggun Jang” through the microphone 200.

Next, the voice recognition engine 201 recognizes the voice command sent from the microphone 200, in step S302. Specifically, the voice comparing unit 201-1 of the voice recognition engine 201 converts the voice command sent from the microphone 200 into a predetermined frequency or a constant level to compare with a reference value stored in the database 201-2, and outputs the recognized voice command.

The voice recognition engine 201 separates the recognized voice command into meaningful terms, in step S303. Specifically, the voice analyzing unit 201-3 analyzes the recognized voice command output from the voice comparing unit 201-1, and separates the recognized voice command into meaningful terms. For example, the voice analyzing unit 201-3 separates the voice command “Search Donggun Jang” into the meaningful terms “Search” and “Donggun Jang”. Here, “Search” is an operation name, and “Donggun Jang” is an object name.

The control unit 202 searches for a database corresponding to the operation name separated by the voice recognition engine 201 within the voice command database 203, in step S304. Specifically, if the recognized voice command including the operation name and the object name is output from the voice recognition engine 201, the control unit, 202 first reads the operation name and finds a database corresponding to the operation name within the voice command database 203. Thereafter, the control unit 202 finds the object name in the found database.

For example, but not by way of limitation, if the recognized voice command including the operation name “Search” and the object name “Donggun Jang” is output from the voice recognition engine 201, the control unit 202 finds the address database 203-4 starting with “Search” by searching for the voice command database 203. Next, the control unit 202 finds the object name “Donggun Jang” by searching for the address book database 203-4. In other words, the control unit 202 searches for only the database corresponding to the operation name without searching through all of the databases included in the voice command database 203, and finds the object name in the searched database.

Next, the control unit 202 determines whether a voice command that is identical to the separated names is found in the corresponding database, in step S305.

In a case where the same command as the input voice command is not found in the corresponding database within the voice command database 203, the user is requested to re-input the voice command, in step S306. When it is impossible for the control unit 202 to search for a database corresponding to the input voice command within the voice command database 203, such as when the user inaccurately inputs the voice command, the control unit 202 requests that the user re-inputs the voice command. Then, the signal processing unit 204 outputs a voice command re-input request signal to the speaker 205 and/or the display unit 206.

If the same command as the input voice command is searched in the corresponding database, the searched command is executed and the execution result is output via the speaker 205 and/or the display unit 206, in step S307. The signal processing unit 204 processes a signal for outputting the voice command execution result to the speaker 205 and/or the display unit 206. For example, the control unit 202 calls out the address of the person “Donggun Jang” from the address book database 203-4 corresponding to the voice command, “Search Donggun Jang” input by the user. Next, The signal processing unit 204 processes the voice command execution signal and outputs the voice command execution result to the speaker 205 and/or the display unit 206.

In the present invention, it is preferable that speech recognition software, which processes voice commands in embedded speech recognition machines (for example, PDA) uses a Windows CE database (CEDB) loaded on WinCE instead of Oracle or MS-SQL and My-SQL for supplying a SQL sentence capable of searching a specific record. In a case where the Oracle or MS-SQL and My-SQL, in which many resources are required, are mounted to the embedded speech recognition machines, there may be a problem of insufficient resources. Thus, it is preferable to use the CEDB loaded on the WinCE.

The present invention may also be implemented as a set of instructions in a computer-readable medium. For example, but not by way of limitation, the computer-readable medium maybe located in the computer or remotely, and the remote computer readable medium may be accessed by wireline or wirelessly.

As described above, according to the present invention, time required to access a database corresponding to a voice command in order to process the voice command input by a user is reduced by constructing databases storing voice commands including an operation name, separating the voice command into meaningful terms, and searching for only a database corresponding to the separated words within the constructed databases.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A voice command processing method comprising:
(a) constructing a plurality of databases in which respective voice commands, including an operation name, are stored in each of said databases;
(b) receiving one of said voice commands and separating the received voice command into terms that include the operation name and an object name;
(c) finding a database corresponding to the operation name within the databases; and
(d) finding the object name in the database corresponding to the operation name found in (c).

2. The method of claim 1, wherein in (a), a database can be added to or deleted from the databases.

3. The method of claim 1, wherein in (c), when the database corresponding to the operation name is not found, re-input of the voice command is requested.

4. A voice command processing system comprising:
a plurality of databases configured to store respective voice commands, each of which includes an operation name;
a separating unit which receives one of said voice commands, and separates the received voice command into the operation name and an object name; and
a control unit which finds a database corresponding to the operation name within the plurality of databases, finds the object name in the found database, and executes the received voice command.

5. The system of claim 4, wherein when the control unit fails to find one of said databases corresponding to the operation name, the control unit requests re-input of the voice command.

6. The system of claim 4, wherein the control unit includes a voice command addition/deletion unit for adding/deleting voice commands for storage in the databases.

7. The system of claim 4, wherein said system is applied to at least one of an embedded mobile terminal, a speech recognition toy, a speech recognition language learning machine, a speech recognition personal communication system, a speech recognition household electric appliance, a speech recognition automated guide system, a speech recognition home automation machine, a speech recognition browser, and a speech recognition stock transaction apparatus.

8. The system of claim 4, further comprising a signal processing unit that receives the executed voice command from said control unit, and outputs said executed voice command to at least one of a speaker and a display unit.

9. The system of claim 4, wherein said separating unit comprises:
a voice comparing unit that receives said voice command and converts said voice command to a frequency to compare with a reference value; and
a voice analyzing unit that analyzes said converted voice command and separates said converted voice command into at least one of said operation name and said object name, for forwarding to said control unit.

10. The method of claim 1, wherein said method is applied to at least one of an embedded mobile terminal, a speech recognition toy, a speech recognition language learning machine, a speech recognition personal communication system, a speech recognition household electric appliance, a speech recognition automated guide system, a speech recognition home automation machine, a speech recognition browser, and a speech recognition stock transaction apparatus.

11. The method of claim 1, further comprising generating an output signal corresponding to said found object name, processing said output signal, and outputting said processed output signal to at least one of a speaker and a display unit.

12. The method of claim 1, wherein (b) comprises:
(b-1) receiving said voice command and converting said voice command to a frequency to compare with a reference value; and
(b-2) analyzing said converted voice command and separating said converted voice command into at least one of said operation name and said object name, for forwarding to a control unit that executes (c) and (d).

13. A computer-readable medium configured to store a set of instructions for voice command processing method, said instructions comprising:
(a) constructing a plurality of databases in which respective voice commands, including an operation name, are stored in each of said databases;
(b) receiving one of said voice commands and separating the received voice command into at least one term that includes the operation name and an object name;
(c) finding a database corresponding to the operation name within the databases; and
(d) finding the object name in the database corresponding to the operation name found in (c).

14. The computer-readable medium of claim 13, wherein in instruction (a), a database can be added to or deleted from the databases.

15. The computer-readable medium of claim 13, wherein in instruction (c), when the database corresponding to the operation name is not found, re-input of the voice command is requested.

16. The computer-readable medium of claim 13, wherein said method is applied to at least one of an embedded mobile terminal, a speech recognition toy, a speech recognition language learning machine, a speech recognition personal communication system, a speech recognition household electric appliance, a speech recognition automated guide system, a speech recognition home automation machine, a speech recognition browser, and a speech recognition stock transaction apparatus.

17. The computer-readable medium of claim 13, further comprising generating an output signal corresponding to said found object name, processing said output signal, and outputting said processed output signal to at least one of a speaker and a display unit.

18. The computer-readable medium of claim 13, wherein instruction (b) comprises:
(b-1) receiving said voice command and converting said voice command to a frequency to compare with a reference value; and
(b-2) analyzing said converted voice command and separating said converted voice command into at least one of said operation name and said object name, for forwarding to a control unit that executes (c) and (d).
